(19) United States
(12) Patent Application Publication
(10) Pub. No.: US 2025/0343784 A1
(43) Pub. Date: Nov. 6, 2025

(54) LIVE MIGRATION FOR CONFIDENTIAL COMPUTE ENVIRONMENTS

(71) Applicant: MELLANOX TECHNOLOGIES, LTD., Yokneam (IL)

(72) Inventor: Boris Pismenny, Vaud (CH)

(21) Appl. No.: 19/015,129

(22) Filed: Jan. 9, 2025

Related U.S. Application Data
(60) Provisional application No. 63/640,980, filed on May 1, 2024.
(60) Provisional application No. 63/669,463, filed on Jul. 10, 2024.

(51) Int. Cl. H04L 9/40; G06F 9/455

(52) U.S. Cl. CPC H04L 63/0428; G06F 9/45558; H04L 63/061; G06F 2009/45595

(57) ABSTRACT

Systems and methods are directed toward migration operations, such as live migration operations, associated with confidential computing environments. Responsive to a request to migrate data, a secure hypervisor may establish a secure communication channel to a network interface controller to pass one or more keys for accessing securely stored data. The secure hypervisor may generate a descriptor associated with a memory location of the data and then pass the descriptor to the network interface controller. As a result, encryption/decryption operations may be offloaded to the network interface controller, which may use the descriptor and key to migrate the data from a source location to a destination location.

### CROSS-REFERENCE TO RELATED APPLICATIONS

This application claims priority to and the benefit of U.S. Provisional Patent Application No. 63/640,980 filed on May 1, 2024 and U.S. Provisional Patent Application No. 63/669,463 filed on Jul. 10, 2024, the disclosures of which are incorporated by reference herein in their entireties for all intents and purposes.

### TECHNICAL FIELD

At least one embodiment pertains to migrating compute services, such as virtual machines. More specifically, at least one embodiment pertains to live migration for confidential compute environments.

### BACKGROUND

Virtual machines (VMs) may be migrated between different underlying physical components, such as servers. During a live migration event, a client or application associated with the VM may maintain its connection to the VM and continue to operate associated applications. Live migration may include moving VM memory, connections, and storage from one underlying hardware component to another. However, with confidential computing environments, trusted VMs are created with protected code and data. The protected code and data may be protected from one or more untrusted hypervisors, which are usually used to control live migration events. As a result, multiple encryption operations, decryption operations, and data copies associated with software abstractions are used to protect confidential information, creating delays and increasing costs.

### BRIEF DESCRIPTION OF THE DRAWINGS

Various embodiments in accordance with the present disclosure will be described with reference to the drawings, in which:

FIG. 1 illustrates an example environment including a migration manager for live migration operations, in accordance with at least one embodiment;

FIG. 2A illustrates an example environment for migrating data from a first location to a second location, in accordance with at least one embodiment;

FIG. 2B illustrates an example environment for migrating data from a first location to a second location, in accordance with at least one embodiment;

FIG. 2C illustrates an example environment for migrating data from a first location to a second location, in accordance with at least one embodiment;

FIG. 3 illustrates an example environment for migrating data from a first location to a second location, in accordance with at least one embodiment;

FIG. 4A illustrates an example process for generating a secure communication channel and descriptor for a live migration operation, in accordance with at least one embodiment;

FIG. 4B illustrates an example process for executing a live migration operation, in accordance with at least one embodiment;

FIG. 5 illustrates an example process for a live migration operation, in accordance with at least one embodiment;

FIG. 6 illustrates components of a distributed system that can be utilized to update or perform inferencing using a machine learning model, according to at least one embodiment;

FIG. 7 illustrates an example data center system, according to at least one embodiment; FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous vehicles or machines (e.g., in an in-cabin infotainment or digital or driver virtual assistant application)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments can be used with VM migration and/or live migration, and in at least one embodiment, in the context of confidential computing. With confidential computing, an untrusted hypervisor (UH) is used to manage live migration operations by transmitting messages to a secure hypervisor (SH), which may then access and interact with a confidential VM (CVM). With traditional methods, when the SH receives a call to begin migration, the SH accesses an encrypted buffer of the CVM (which is encrypted by a memory management controller), copies the information to its plaintext buffer, and then provides the information to an encrypted buffer of the UH, which is then transmitted to a network interface controller (NIC). The reverse process may then be used to mount the CVM to a new location, which may include using a different datacenter, different underlying hardware, and/or the like. Systems and methods of the preset disclosure remove one or more intermediate encryption steps associated with the UH by establishing a secure channel between the SH and the NIC to pass a key. Thereafter, upon receiving instructions to begin live migration (or some other operation), the SH may pass a descriptor of the data location to the NIC via the UH. In contrast to traditional systems, embodiments of the present disclosure include the NIC being trusted by the SH. Generally, SH memory is not accessible using direct memory access (DMA). By trusting the NIC, the NIC may access SH memory, for example by using the TEE Device Interface Secure Protocol (TDISP). The descriptor may point to either the plaintext buffer of the SH or directly to the encrypted buffer of the CVM. In this manner, the intermediate encryption step is removed and plaintext descriptors may be passed in place of the encrypted data of traditional methods. Upon receipt, the NIC can use the key to access the locations defined by the descriptor and move the data to the new location. Accordingly, operations, such as live migration, may be performed faster, decreasing a likelihood that data will be changed during migration, and may also overcome memory bottlenecks caused by copying between different buffers. Furthermore, in various embodiments, the UH may be included in the process or may be omitted from the process. For example, communication may be directed through the UH, but various other embodiments may include direct communication between the SH and the NIC.

Various embodiments are directed toward facilitating migration, such as live migration, for distributed compute applications, which may include confidential computing applications. Embodiments are directed toward overcoming problems with existing systems that include various additional encryption steps, which may be computationally costly and/or time consuming. When migration time increases, there may be an increased likelihood of incomplete migration. With incomplete migration, one or more aspects of the target VM may change during the migration, which may include receiving data after migration begins, and/or other changes. As a result, one or more additional steps may be performed to complete migration after traffic is redirected to the new location, such as additional copying and/or transmitting of information. This increased cost is undesirable and also consumes bandwidth and underlying resources. Systems and methods may reduce the likelihood of incomplete migration by implementing one or more operations that reduce or eliminate one or more encryption/decryption steps, thereby increasing migration speed.

To address the various problems associated with traditional migration and/or live migration operations, various embodiments offload encryption/decryption on a source/destination compute component to a trusted NIC, which may use a variety of different transport protocols. For example, current applications may use a trusted software component to perform encryption by itself using one or more central processing units (CPUs), which may be a weak embedded CPU resource that adds latency to the migration process when performing different encryption/decryption operations. While the trusted component may interact with one or more NICs, the NIC is used passively to transmit information and does not implement or use the processing capabilities of the NIC. For example, TDISP may enable the NIC to interact with CVMs, but not the SH. Embodiments of the present disclosure may offload one or more processing steps to the NIC to reduce and/or remove encryption/decryption steps associated with the UH. When the UH calls the compute component to obtain encrypted pages, the UH may provide an indication to implement cryptographic capabilities of the trusted NIC. In certain embodiments, the compute component may be used to identify and/or notify NICs having sufficient processing capabilities to execute cryptographic algorithms. In response, a trusted CPU component registers plaintext source VM memory and returns a descriptor to the UH, which the trusted NIC can use to access the plaintext source VM pages. The UH may perform all transport operations and/or substantially all transport operations using the descriptor to represent the transmitted data and the descriptor, upon reaching the device driver, will permit the trusted NIC access to the plaintext data and send it encrypted to the destination. Symmetrically, at the destination, the UH pre-registers compute component memory with the trusted NIC. In at least one embodiment, direct memory access (DMA) writes decrypted data directly to compute component memory using a zero-copy approach. The UH receives a descriptor indicating where memory is placed and provides the information to the compute component after performing any remaining transport operations on the compute component.

Embodiments of the present disclosure address and overcome problems associated with live migration, for example live migration with confidential compute environments. For example, live migration in confidential compute environments uses encryption that is computationally costly on CPUs because the operations are typically more than one data copy in addition to encryption. To solve at least this problem, among others, embodiments add NIC and/or data processing units (DPUs) to the trusted computing base (TCB) of VMs and enables the SH to leverage NIC crypto offload to assist live migration and DMA, for zero-copy operations.

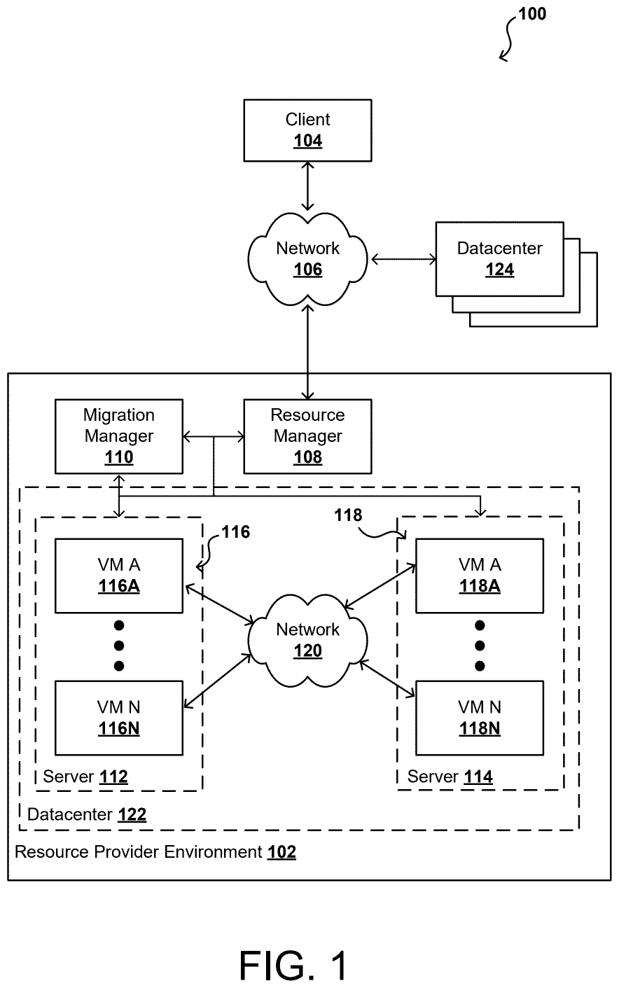

FIG. 1 illustrates an environment 100 that may be used with embodiments of the present disclosure. In this example, a resource provider environment 102 is used to host or otherwise provide access to one or more underlying resources, such as compute resources, storage resources, and/or the like. It should be appreciated that various other components may also be included, or hosted separately in a different environment, and are not shown for clarity with the following discussion. Furthermore, various components are shown by way of example and are not intended to limit the scope of the present disclosure. Resources described with respect to the resource provider environment 102 can include physical and virtual resources, such as both underlying hardware and software executing on the underlying hardware. Moreover, various resources may be illustrated as separate blocks or components, but different embodiments may group or otherwise share functionality between different blocks or components.

In this example, client 104 (e.g., a node, a user, a user device, a client device, etc.) can send and/or receive traffic to/from the resource provider environment 102 over one or more networks 106. The client 104 and/or a client device may be referred to interchangeably in that the client device facilities the interaction with the resource provider environment 102. Furthermore, the client 104 may be representative of one or more nodes, which may include multiple devices executing one or more workflows. The client device can include any appropriate electronic device operable to send and receive requests, messages, or other such information over an appropriate network and convey information back to a user of the device and/or convey information that can be confirmed or otherwise analyzed by software executing on the device. Examples of such client devices include personal computers, tablet computers, smart phones, notebook computers, various edge devices, servers, and the like. Further, while the client device 104 is illustrated as being external to the resource provider environment 102, various embodiments may be directed toward client device(s) 104 that are within or part of the resource provider environment 102, such as one or more servers or compute resources being used by a client. Additionally, the network(s) 106 may include a variety of different networks, including but not limited to, an intranet, the Internet, a cellular network, a local area network (LAN), and other such networks and/or combinations thereof. The network 106 may be a wired or wireless network. Furthermore, a variety of different network protocols may be used to transmit information using the one or more networks 106.

The resource provider environment 102 may be a “cloud” provider network that is a pool of network-accessible computing resources (such as compute, storage, networking, applications, and services), which may be virtualized or bare-metal. These resources can be dynamically provisioned and reconfigured to adjust to variable load. The cloud provider network may implement various computing resources or services, which may include a virtual compute service (referred to in various implementations as an elastic compute service, a VM service, a computing cloud service, a compute engine, or a cloud compute service), data processing service(s), data storage services (e.g., cloud disks service, a managed disk service, a storage area network service, a persistent disk service, or a block volumes service), and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider.

In this example, traffic, which may be a request, a data stream, a message, and/or the like, can be received by a resource manager 108. The resource manager 108 may be an interface between the resource provider environment 102 and the client 104 and may included components such as application programming interfaces (APIs), load balancers, data routers, and/or the like. In various embodiments, the traffic may include one or more portions of a workflow associated with the client 104, such as a workflow to execute compute operations, to execute storage operations, and/or the like. Additionally, the traffic may also include messages transmitted between the client 104 and the resource provider environment 102, such as confirmation messages regarding a state or status of various components of the resource provider environment 102, instructions to execute one or more operations, and/or the like.

In this example, where one or more workflows may be associated with migrating VMs and/or portions thereof, the resource manager 108 may route information to a migration manager 110 and/or one or more servers 112, 114. In this example, the servers 112, 114 include underlying hardware components that may execute one or more software applications, which in this non-limiting example include virtualized applications referred to as VMs 116, 118 and/or as CVMs, as discussed herein. As discussed herein, specific VMs, servers, and other components may be designated by a letter for clarity (e.g., VM A 116A, VM A 118A, etc.). It should be appreciated that the use of the same range of letters (A-N) is by way of non-limiting example and is not intended to limit embodiments to servers or resources that use the same number of VMs 116, 118. For example, different servers may be executing different VMs 116, 118 based on specifications of the underlying hardware, settings established by one or more users, and/or the like. Further, various embodiments may illustrate the migration manager 110 as a separate component, but it should be appreciated that one or more portions of the migration manager 110 may be executed on the servers 112, 114 and/or be incorporated into software executing on the servers 112, 114 such as a hypervisor executing on the servers 112, 114 to create and monitor the VMs 116, 118.

Various embodiments may also include an internal network 120 for communication and/or data transmission between the different servers 112, 114 and other various components, which as noted herein, may be a wired or wireless network. The internal network 120 may be used to facilitate reliable connections between individual servers 112, 114 and/or with the client 104. In one or more embodiments, the internal network 120 may be a common or shared with the network 106, and therefore, illustration as a separate network is provided by way of example only. Furthermore, it should be appreciated that various embodiments may also be used to transmit information between different physical locations associated with resource provider environments 102. As noted, the resource provider environment 102 may include one or more locations that include various hardware components. One or more of these components may be positioned within a datacenter 122, which may be configured to communicate with one or more additional datacenters 124 Representations of servers 112, 114 and/or datacenters 122, 124 are provided by way of example because different VMs in different datacenters may be used to communicate with one another and/or to execute one or more workloads. Furthermore, traffic may be routed in accordance with various polices and/or to adjust for different preferences, such as low latency, high throughout, certain types of data storage, and/or the like.

In operation, it may be beneficial to migrate or move VMs 116, 118 between different servers 112, 114 (e.g., to different underlying hardware). Migration of VMs 116, 118 may enable updates or maintenance for the underlying hardware and/or may be used to modify operational capabilities of the VMs 116, 118. For example, a VM may be moved to a server that has higher performing underlying hardware which may enable different or improved operations for the VM. In another example, the VMs may be moved to datacenters that are physically closer to a traffic source (e.g., a source node) to reduce latency. As another example, VMs may be migrated responsive to maintenance on underlying resources or responsive to outages (e.g., power outages, natural disasters, etc.) to maintain operability for end users. Migrating VMs may be performed as a “live migration” where a VM is moved from one physical machine (e.g., a server) to another, even as its applications continue to execute during migration. A live migration event may include steps such as memory state migration, CPU state migration, and virtual disk state migration. A migration manager may be used to transfer data from the VM's memory to a target machine, create the CPU state on the target machine (e.g., states of the CPU, memory, and storage), and then suspend the VM for copy and initialization at the target machine. The process may minimize downtime, but as noted herein, the suspension of the VM occurs prior to initialization at the target machine. During the downtime (e.g., when the VM is suspended), if one or more clients or other resources send traffic (e.g., a message, a data stream, etc.) to the VM, the sender may not receive an acknowledgement of receipt of the information and log a timeout event. In another embodiment, data may continue to be processed by the source node after migration of information has started to a target node, and therefore, the new data may not be fully transmitted. With confidential compute operations, risks of timeouts or incomplete migration may increase due to the extra time and computational resources used with various cryptography operations to move confidential information using one or more UHs. Systems and methods of the present disclosure may be used during VM migration, such as confidential compute live migration, to eliminate and/or reduce various cryptography operations.

In at least one embodiment, systems and methods may address problems with existing techniques by establishing one or both of a data communication channel and a secure communication channel to a network component, such as a NIC, using one or more SHs. The SHs may use the UH as an intermediate component for communication with the NIC. In order to bypass encryption/decryption associated with the UH, the secure communication channel may be used to transmit an appropriate key associated with encrypted data to be transmitted using the NIC. That is, instead of using an encrypted buffer associated with the UH, embodiments may bypass the UH in favor of providing a key for accessing the migrating data to the NIC. Thereafter, one or more embodiments may include providing a descriptor, which may be a plaintext descriptor, directing the NIC to the appropriate data location that may then be accessed using the key. The descriptor may be passed using the communication channel via the UH. While the descriptor may be passed as an encrypted messages because it may originate from the SH, the descriptor may only provide data location information and may not include the actual encrypted data associated with the data location. Therefore, even if a malicious actor were to obtain the descriptor, and be able to decrypt the messages, without the key the malicious actor would not be able to access the secure information.

Systems and methods may also be used to facilitate migration between a source location and a memory location. As discussed herein, migration may be controlled or otherwise managed using one or more UHs. The UH may provide calls to one or more SHs to facilitate migration of confidential information, which the UH may not be able to access, but may be able to provide instructions to the SH as an interface to migration. One or more embodiments may use a secure channel formed between the SH and one or more network components, such as a NIC. The NIC may include its own processing capabilities, such as a DPU or other processor, and may also be a trusted component. For example, the NIC may include hardware or firmware components that include cryptographic capabilities that enable key sharing, authentication, and/or the like. In certain embodiments, the processing units of the NIC may be particularly selected for cryptographic operations, which may reduce latencies associated with migration. The NIC may receive a key from the SH that is transmitted using the secure channel. The secure channel may “pass through” the UH and/or may be a separate communication channel directly between the NIC and the SH. In at least one embodiment, the key may be used to access information to be migrated that is stored within one or more encrypted buffers and/or to access data stored within the SH. As discussed herein, the NIC may receive, via the SH and/or the UH, a descriptor describing the location of the information associated with the source location. The descriptor may then be used by the NIC to identify the memory location associated with the information and then the information may be accessed and/or migrated using the received key.

One or more embodiments may also use symmetric or partially symmetric operations for both accessing stored information at a first location and then storing the information at a second location. For example, a first SH may receive a command, which may be from a first UH, to move data from a first encrypted memory location to a second encrypted memory location. The encrypted memory locations may be inaccessible to the first UH. In at least one embodiment, a first secure channel may be formed between the first SH and a first NIC, which may permit passage of a key to the first NIC to access the first encrypted memory location. The NIC may be a trusted component that includes cryptographic properties, as discussed herein. In at least one embodiment, location information for the first encrypted memory location may be provided in the form of a descriptor that describes the location in the first encrypted memory location of the data to be migrated, but does not include the encrypted data itself. The descriptor may be provided as part of an encrypted communication from the first SH. The first NIC may receive both the key and the descriptor, which may be passed along different communication channels, and may then provide the key and descriptor to a second NIC using one or more networks. The second NIC may then be used to facilitate transfer to the second encrypted memory location. For example, a second SH may receive information related to the data in the first encrypted memory location and then facilitate transfer of the data to one or more secure locations.

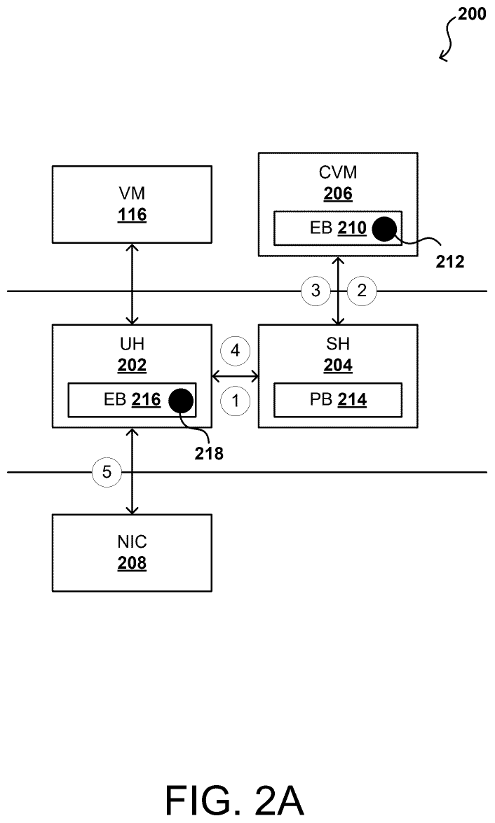

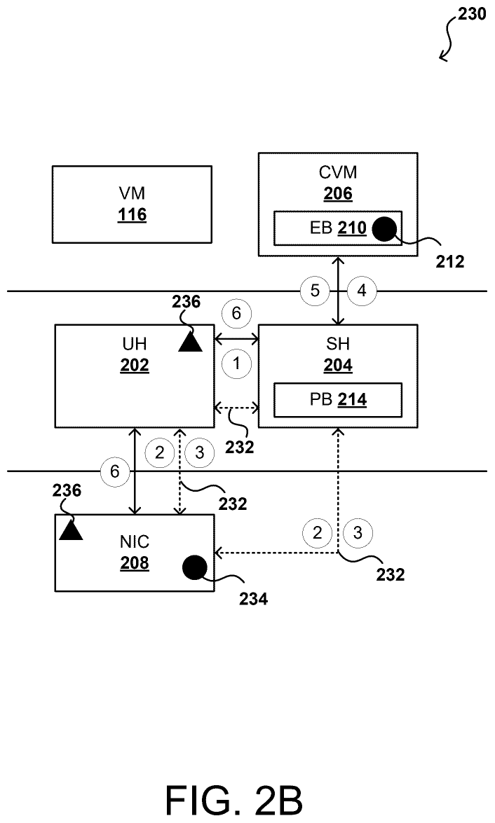

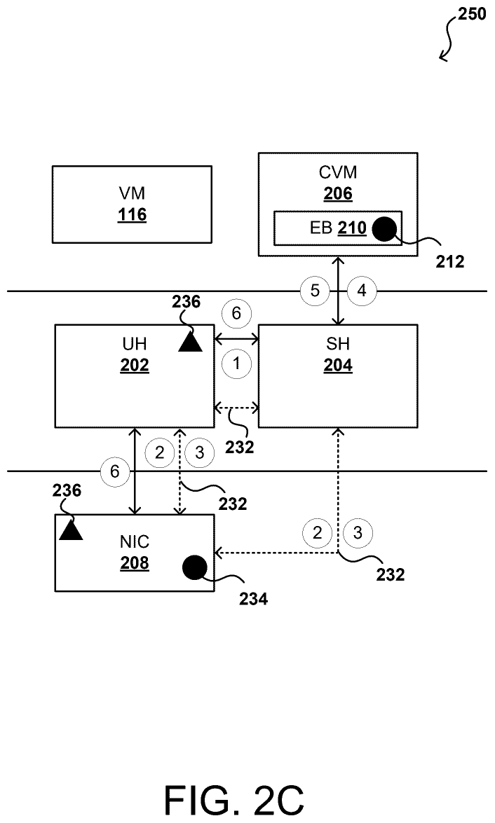

FIG. 2A illustrates an example environment 200 for live migration that may be used with embodiments of the present disclosure. In this example, a UH 202 is used to manage and or direct various portions of the live migration process. The UH may be referred to as being “untrusted” because there may be one or more secure compute assurances missing from the UH 202, such as lacking different encryption protocols, lacking certain permissions, and/or the like. In other words, components that cannot be verified as being trusted, which may be based on hardware or firmware configurations, may be deemed untrusted. In this example, because the UH 202 is untrusted, it cannot access and/or communicate directly with secured or otherwise trusted resources. Accordingly, instead of facilitating migration directly, the UH 202 may communicate with one or more SHs 204. In contrast to the UH 202, the SH 204 may be associated with and/or have access to different cryptographic protocols and/or keys to secure the data associated with one or more VMs. For example, different VMs 116 may execute along with one or more CVMs 206.

Normally, the UH 202 may be permitted to perform most or all actions associated with various VMs 116, but because the UH 202 is “untrusted,” collaboration with one or more trusted components may be used for live migration in confidential computing environments. For example, the UH 202 may be used to find source and/or destination locations, facilitate communication with trusted components, provide instructions to the trusted components regarding the data (e.g., pages) to access for migration, and then send the encrypted information.

To facilitate VM migration in confidential computing, one or more compute components (e.g., CPUs) may implement one or more trusted cryptographic operations, such as a trusted platform module (TPM) or other secure hardware component. Thereafter, the steps for live migration may include using the UH to communicate over the network between a source and a destination, for example via one or more NICs 208. The communication across the NIC 208 may include exchanging various information to perform a handshake to trust and/or ensure the destination is a desired and/or trusted location. As shown by the numeral 1, the UH 202 calls the SH 204 to begin a migration operation. Because the SH 204 is a secured component, the SH 204 may be permitted access to the CVM 206. For example, the SH 204 may read from an encrypted buffer (EB) 210 of the CMV 206, as shown by the numeral 2. In at least one embodiment, the EB 210 may be encrypted by one or more keys 212. The SH 204 may copy the data from the EB 210 to a plaintext buffer (PB) 214, as shown by the numeral 3.

The live migration process may continue, as shown by the numeral 4, by writing at least a portion of the content of the PB 214 to an EB 216 of the UH 202, which may also be secured by one or more keys 218. The encrypted data from the UH 202 may then be passed to the NIC 208, as shown by the numeral 5, for transmission to the destination location. The entire process may then be reversed/repeated at the destination location. For example, a destination UH may receive the content of the EB 216 to another EB, which is then read by another SH, which can then write the data to a destination CVM. As shown, the process of FIG. 2A may be both time and resource intensive. For example, multiple encryption processes are included along the pathway because the data is passing through the UH 202, which as discussed herein, is untrusted, and therefore, cannot be permitted to see the plaintext of the CVM. Embodiments address and overcome these problems, among others, by offloading encryption/decryption processes to the NIC 208.

FIG. 2B illustrates an environment 230 that may be used with embodiments of the present disclosure for VM migration, such as confidential computing live migration. One or more embodiments may be used to transmit data directly from the SH PB 214, thereby skipping encryption at the UH 202. Systems and methods may be used to transmit a memory location descriptor using one or more secure channels. Furthermore, various embodiments may offload one or more encryption/decryption operations to the NIC 208.

In this example, the UH 202 begins and/or manages one or more portions of the migration process, however, as discussed herein, the UH 202 is no longer a recipient of the encrypted data from the SH 204, and as a result, one or more encryption processes may be removed from the live migration procedure. It should be appreciated that while various embodiments may describe using the SH, systems and methods may also replace the SH with a trusted VM. Such an implementation may be referred to as a VM-assisted approach where the trusted VM can access the memory of all confidential VMs. For example, a migration assistant VM may include one or more drivers for direct access to hardware, such as the NIC 208, and then offload encryption operations. In the illustrated example, the UH 202 may initialize the live migration event, as shown by the numeral 1, by communicating with the SH 204. In order to perform the live migration, in this example, a secure channel 232 (represented by the dashed line) is established between the SH 204 and the NIC 208, as shown by the numeral 2. The secure channel 232 may “pass through” the UH 202 or be formed as a direct communication pathway between the SH 204 and the NIC 208. The secure channel 232 may correspond to any type of secure connection that may permit transmission of information between two locations. In at least one embodiment, different protocols for the secure channel 232 may be stored on or otherwise associated with firmware of the NIC 208. The secure channel 232 may be used to pass one or more keys 234 to the NIC 208 from the SH 204, as shown by the numeral 3. The one or more keys 234 may be used to access data stored within the EB 210 and/or the PB 214, as discussed herein.

After receiving the call to begin the live migration process, the SH 204 may access data associated with the CVM 206, for example from the EB 210, as shown by the numeral 4. In at least one embodiment, the EB 210 may be encrypted using the one or more keys 212. Information from the EB 210 may then be stored to the PB 214, as shown by the numeral 5. In this example, the encrypted buffer of the UH 202 may be eliminated from the process by passing a descriptor 236 of the data location, as shown by the numeral 6. The descriptor 236 may be transmitted as an encrypted message, but may be a plaintext descriptor. In at least one embodiment, the descriptor 236 provides information associated with a location of data to be transferred during migration, but the data itself is encrypted by the memory controller. The NIC 208 may use the one or more keys 234 to access the PB 214, for example using the secure channel 232, and thereafter pass the information, through another secure channel, to the destination SH. In this manner, encryption/decryption is offloaded and the plaintext descriptor may be passed in place of the encrypted data.

FIG. 2C illustrates an environment 250 that may be used with embodiments of the present disclosure for VM migration, such as confidential computing live migration. One or more embodiments may be used to transmit data directly from the CVM EB 210, thereby skipping encryption at the UH 202 and also reducing memory bandwidth limitations using a zero-copy method. Systems and methods may be used to transmit the memory location descriptor 236 using the one or more secure channels 232. Furthermore, various embodiments may offload one or more encryption/decryption operations to the NIC 208.

The example illustrated in FIG. 2C provides the NIC 208 direct access to the EB 210 using one or more descriptors 236 passed, from the SH 204, which may be used to point to the desired memory location at the source CVM 206. As discussed herein, embodiments may include the UH 202 passing a call to the SH 204 to begin the live migration, as shown by the numeral 1. The secure channel 232 may be established between the SH 204 and the NIC 208, as shown by the numeral 2, which may be used for transmission of the one or more keys 234 to the NIC 208, as shown by the numeral 3. As a result, later encryption/decryption may be executed at the NIC 208 because the NIC 208 now has the one or more keys 234 for accessing the EB 210.

As migration continues, the SH 204 may then access the EB 210, as shown by the numeral 4, and identify the appropriate memory location, as shown by the numeral 5, to generate the descriptor 236. The SH 204 may then pass the descriptor 236 to the NIC 208, as shown by the numeral 6. In at least one embodiment, as discussed herein, the descriptor 236 and the one or more keys 234 may be passed along different communication pathways. However, in certain embodiments, the secure channel 232 may be used to pass both the one or more keys 234 and the descriptor 236 to the NIC 208. The NIC 208 may then directly access the EB 210, for example using the one or more keys 234, and transmit the identified memory from the source location to the destination location.

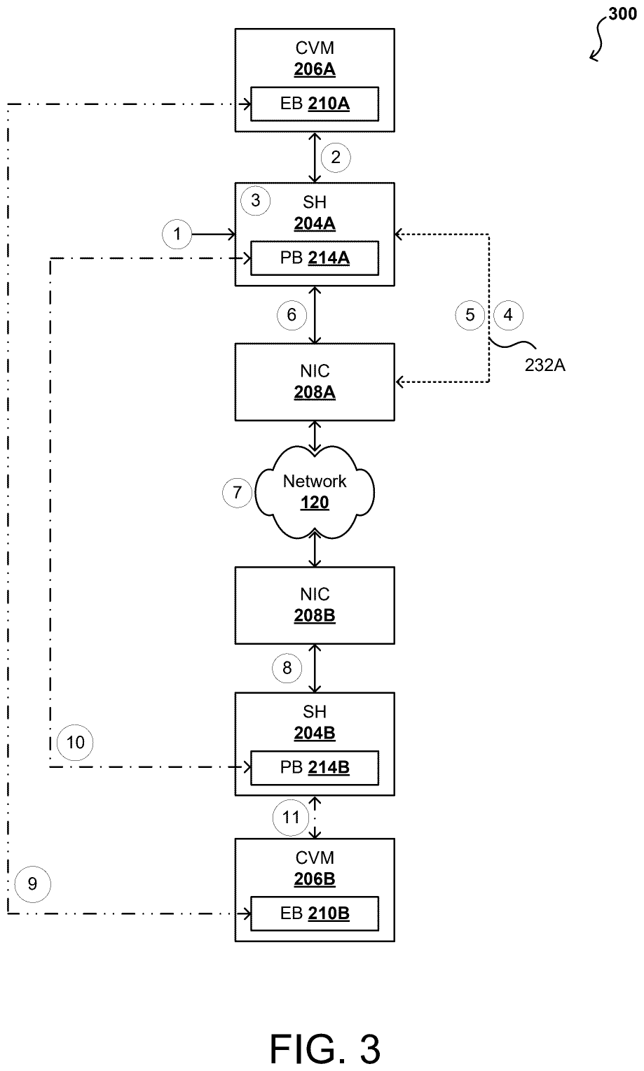

FIG. 3 illustrates an example environment 300 that may be used with embodiments of the present disclosure to execute a live migration operation, such as a live migration operation associated with confidential computing. In at least one embodiment, the live migration operation may include additional components that have been removed for clarity, such as one or more UHs, memory management controllers, migration controllers, and/or the like. In this example, the CVM 206A corresponds to a source location and the CVM 206B corresponds to a destination location. Similarly, other components denoted with “A” may correspond to source-side components while components denoted with “B” may correspond to destination-side components.

At the numeral 1, a call may be received by the SH 204A to begin a live migration process, for example from a UH (not pictured). The UH may be associated with one or more datacenters or racks and may be an untrusted component that does not include one or more embedded hardware components, as one example, to permit various trusted cryptographic operations. The SH 204A may be a trusted component, and therefore, may read data from the EB 210A of the CVM 206A, which may be data encrypted by one or more keys, as shown by the numeral 2. In certain embodiments, the data from the EB 210A may be copied to the PB 214A of the SH 204A. In other embodiments, the data location within the EB 210A may be determined, but the data may not be copied to the PB 214A, for example, when using a zero-copy operation. A descriptor associated with the data location may then be generated, as shown by the numeral 3.

In at least one embodiment, the SH 204A may also establish the one or more secure communication channels 232A to the NIC 208A, as shown by the numeral 4. It should be appreciated that the one or more secure channels 232A may be established before, after, simultaneously, or at least partially simultaneously with reading the data of the CVM 206A and/or generating the descriptor. The one or more secure communication channels 232A may be used to pass one or more keys to the NIC 208A, as shown by the numeral 5. The NIC 208A, using the one or more keys, may then access data associated with one or both of the EB 210A and/or the PB 214A.

The SH 204A may then pass the descriptor associated with the data location to the NIC 208A, as shown by the numeral 6. As noted herein, the descriptor may be passed before, after, simultaneously, or at least partially simultaneously with the one or more keys. The descriptor may be a plain text descriptor, as discussed herein, but the transmission may be an encrypted transmission because the SH 204A is a trusted component. The NIC 208A may then interface with the network 120 to provide the descriptor to the associated destination-side NIC 208B, as shown by the numeral 7. The NIC 208B may then provide the descriptor to the SH 204B, as shown by the numeral 8. In at least one embodiment, the one or more keys may also be provided to the NIC 208B.

In at least one embodiment, the descriptor includes a memory location corresponding to the data within the PB 214A and/or the EB 210A. The SH 204B may then facilitate copying using the one or more keys and the descriptor, as shown by the numerals 9, 10, and 11. For example, number 9 illustrates a zero-copy operation that transmits information from the EB 210A to the EB 210B. However, numerals 10 and 11 illustrate pulling data from the PB 214A to the PB 214B and then subsequently providing the data from the PB 214B to the EB 210B. As discussed herein, the process of using the secure channel 232A to pass the one or more keys along with the descriptor, which may be passed using the secure channel 232A or another channel, bypasses copy and encryption processes using one or more UHs. Instead, as shown, the PB 214B and/or the EB 210B can directly access the desired memory location. The data may then be considered migrated from the source to the destination

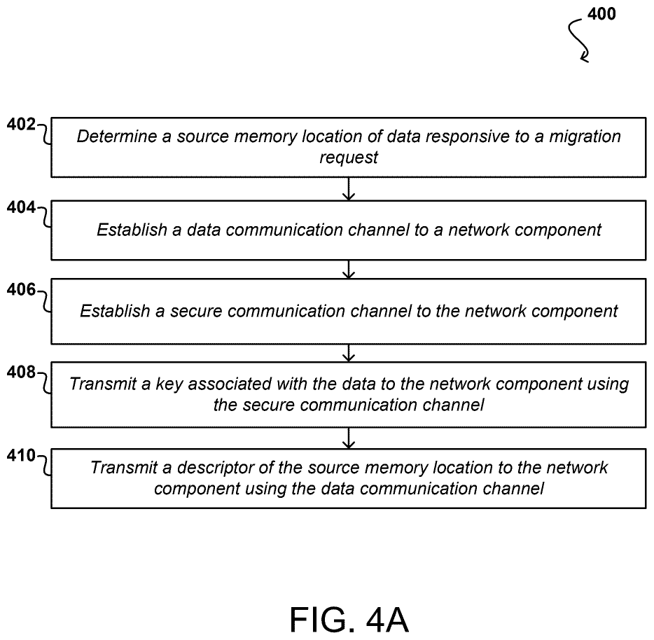

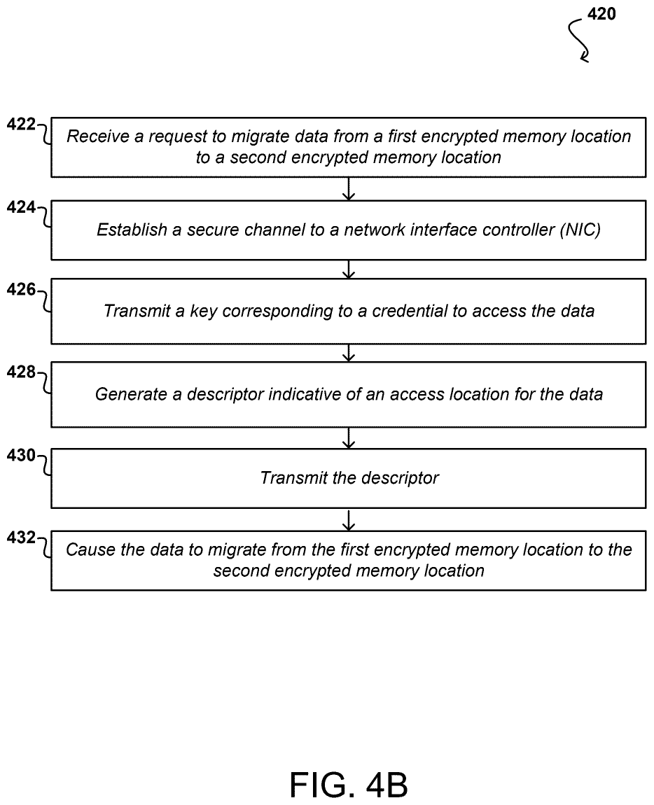

FIG. 4A illustrates an example process 400 that can be used to perform a live migration operation, in accordance with embodiments of the present disclosure. It should be understood that for this and other processes presented herein that there may be additional, fewer, or alternative operations performed in similar or alternative orders, or at least partially in parallel, within the scope of the various embodiments unless otherwise specifically stated. In this example, a source memory location of data responsive to a migration request is determined 402. For example, a memory location within an encrypted buffer may be identified in accordance with a call to begin migration of data from a source location to a destination location. A data communication channel to a network component may be established 404. For example, a handshake request may be established to ensure a trusted connection is established between two different endpoints. A secure communication channel to the network component may also be established 406. The secure communication channel may be different from the data communication channel and may be used to transmit one or more keys or other secure information.

In at least one embodiment, a key associated with the data is transmitted using the secure communication channel 408. The key may be a private key associated with one or more encrypted buffers, such as an encrypted buffer associated with a CVM and/or an encrypted buffer associated with a SH. The secure channel may also be used to transmit instructions to access one or more pre-stored or pre-loaded keys associated with different hardware components. A descriptor of the source memory location may also be transmitted to the network component using the data communication channel 410. In at least one embodiment, the descriptor may be encrypted, but may be in the form of a plaintext descriptor. The descriptor may only provide information associated with where memory is stored, but by itself, does not provide authorization to access the data without the appropriate key. Upon receiving the descriptor and key, the network component may transmit the information to the appropriate destination components to permit data migration from the source to the destination.

FIG. 4B illustrates an example process 420 that can be used for data transmission, such as during a live migration event. In this example, a request is received to migrate data from a first encrypted memory location to a second encrypted memory location 422. The request may be received from a UH. For example, the UH may be used to manage or otherwise control certain aspects of a migration operation, such as live migration, but may not be trusted with receiving and/or accessing specific data for certain VMs, which may be associated with different confidential computing operations. A secure channel may be established to a NIC 424. The secure channel may be provided between the NIC and a SH and may be routed or otherwise directed through the UH. A key corresponding to a credential to access the data may be transmitted over the secure channel 426. For example, the key may be passed to one or more NICs, which may then proceed to transmit the key to another component and/or may use the key to facilitate data transfer.

In at least one embodiment, a descriptor of an access location for the data may be generated 428. The descriptor may be a plaintext descriptor providing information for where certain information is stored. As discussed herein, the descriptor may not be a credential to access the data, and as a result, having the descriptor may not provide sufficient information to access the secured data. The descriptor may be transmitted 430, for example using the UH, and in at least one embodiment, the descriptor may be transmitted using an encrypted message. The descriptor and key may then be used to cause data to migrate 432 from the first encrypted memory location to the second encrypted memory location.

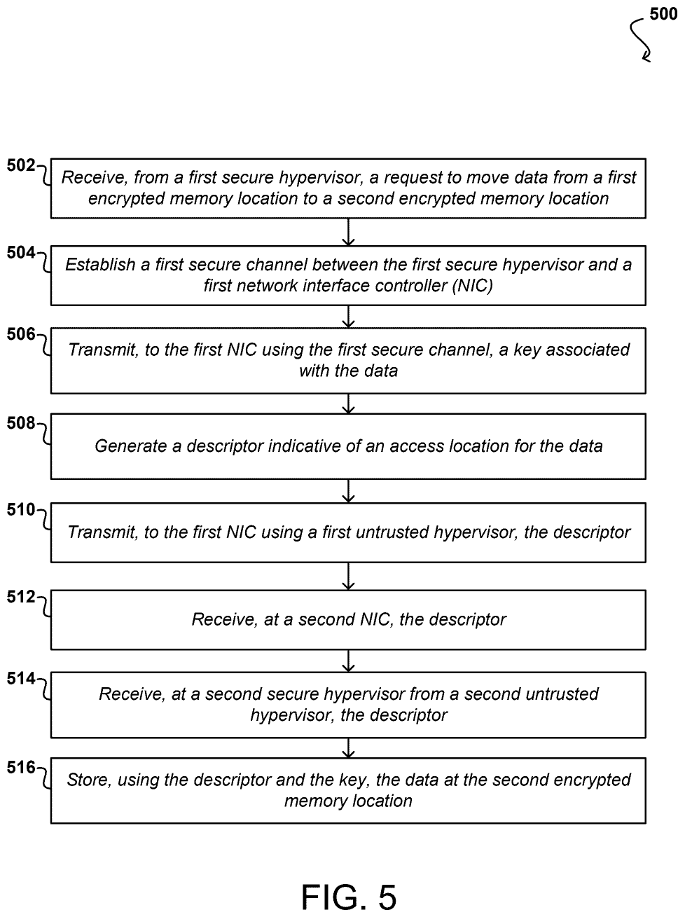

FIG. 5 illustrates an example process 500 for migrating data from a source location to a destination location. In this example, a request to move data from a first encrypted memory location to a second memory location is received 502. The request may be received at a first SH from a first UH. For example, the first UH may be used to monitor and control migration, but may not be permitted to access data for certain VMs, such as CVMs. As a result, the first UH may interface with trusted components in order to direct data migration. A first secure channel may be established between the first SH and a first NIC 504. Additionally, the first secure channel may be used to transmit a key associated with the data 506. The key may be provided to the first NIC from the first SH.

In at least one embodiment, a descriptor may be generated indicative of an access location for the data 508. The descriptor may be a representation of a memory location, but as discussed herein, may not contain the secure or encrypted data stored at the location. The descriptor may be transmitted to the first NIC using the first UH 510. Because the descriptor originates from the first SH, the communication including the descriptor may be an encrypted communication. The descriptor may be received at a second NIC associated with the second encrypted memory location 512. In at least one embodiment, a second SH receives the descriptor 514, for example, from a second UH. The descriptor and the key may then be used to transmit the data from the first encrypted memory location and to store 516 the data at the second encrypted memory location.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

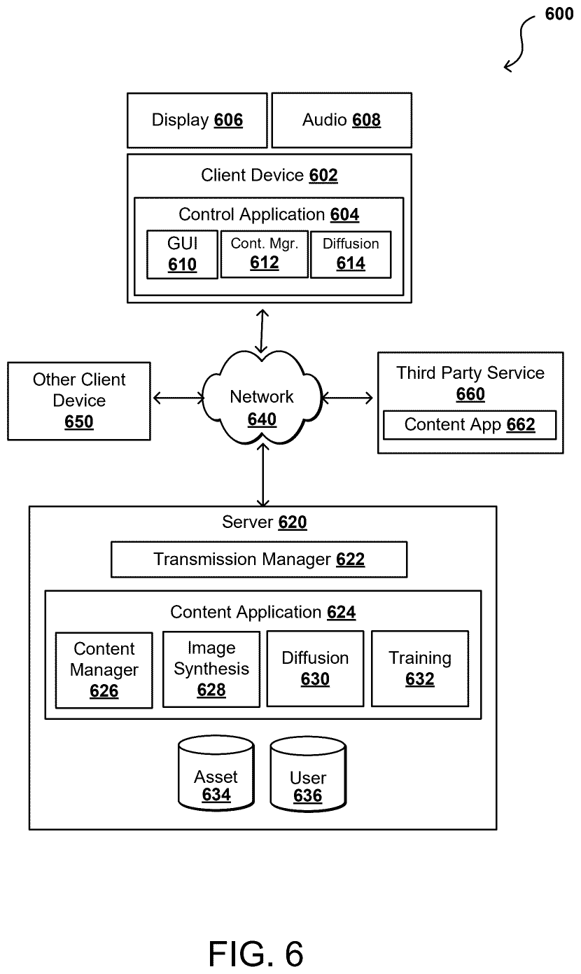

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., object representations) from an asset repository 634 to be determined by a content manager 626. A content manager 626 may work with an image synthesis module 628 to generate or synthesize new objects, digital assets, or other such content to be provided for presentation via the client device 602. In at least one embodiment, this image synthesis module 628 can use one or more neural networks, or machine learning models, which can be trained or updated using a training module 632 or system that is on, or in communication with, the server 620. This can include training and/or using a diffusion model 630 to generate content tiles that can be used by an image synthesis module 628, for example, to apply a non-repeating texture to a region of an environment for which image or video data is to be presented via a client device 602. At least a portion of the generated content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, content manager 612, and image synthesis or diffusion module 614 for use in providing, synthesizing, modifying, or using content for presentation (or other purposes) on or by the client device 602. A decoder may also be used to decode data received over the network 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### DATA CENTER

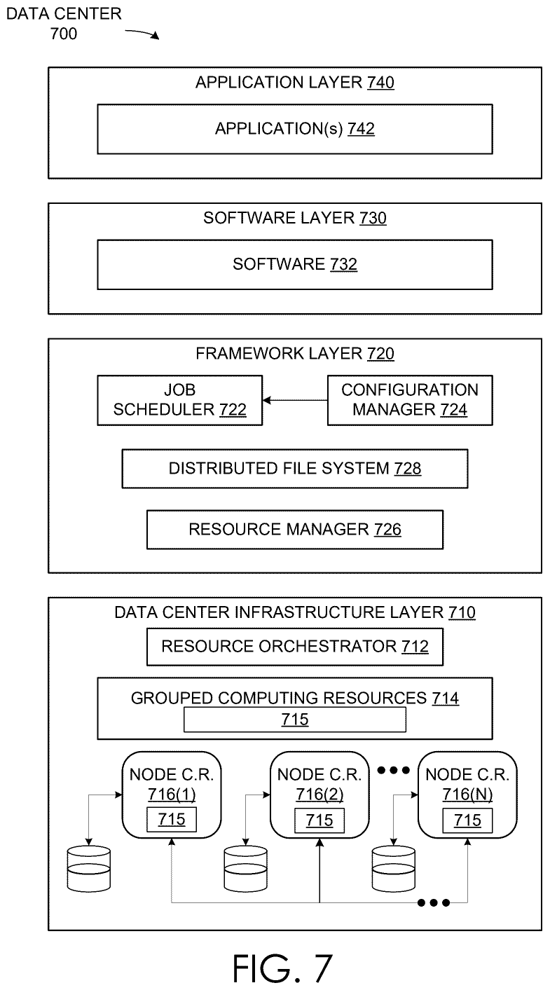

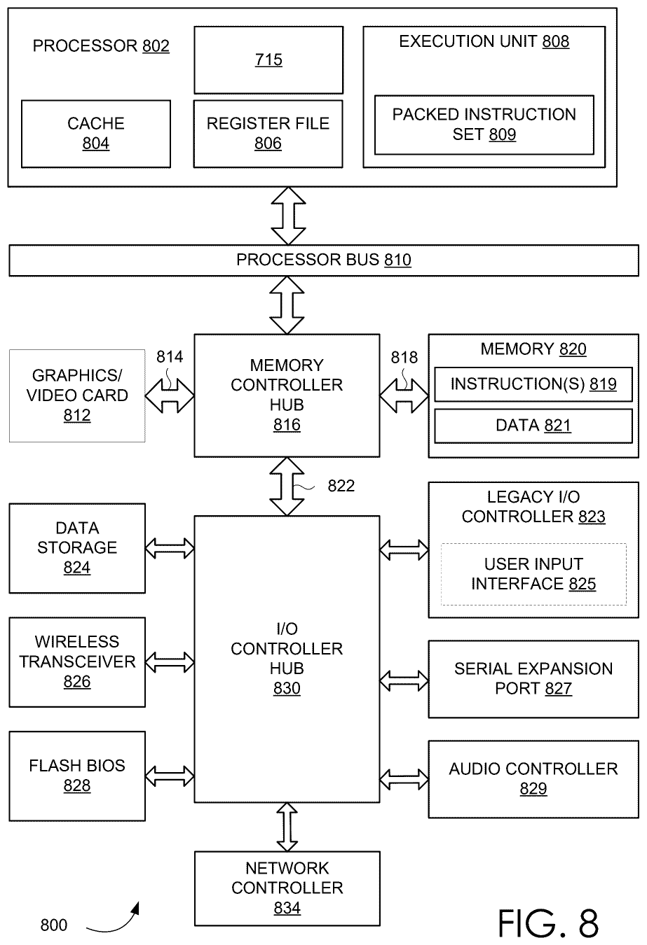

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“'SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 814 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

Such components can be used for live migration.

### COMPUTER SYSTEMS

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interface(s) 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Inference and/or training logic 715 are used to perform inferencing and/or training operations associated with one or more embodiments. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used for live migration.

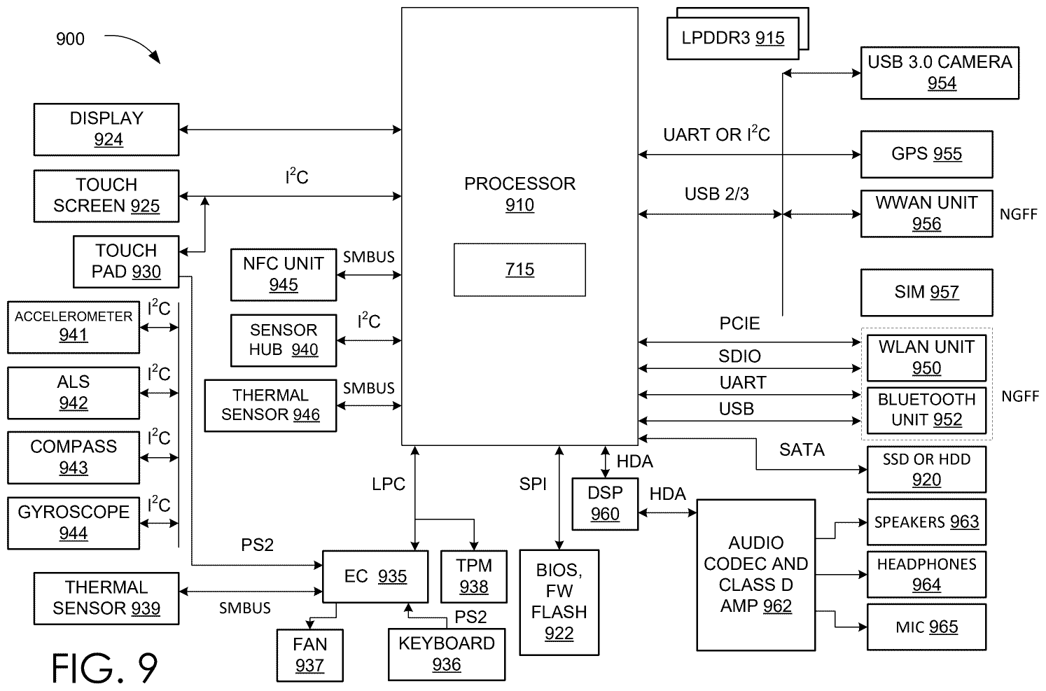

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speakers 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used for live migration.

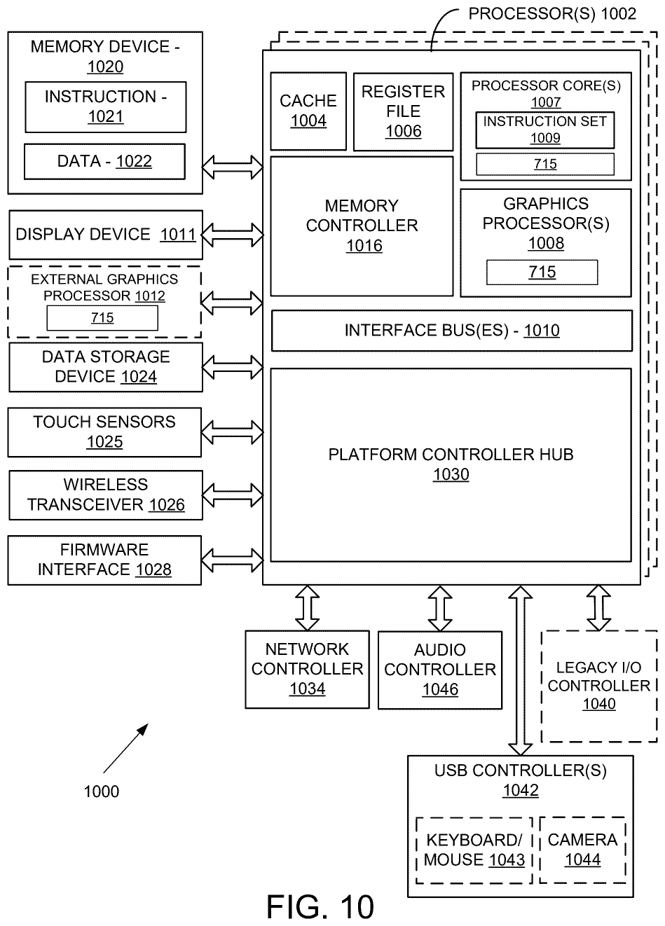

FIG. 10 is a block diagram of a processing system, according to at least one embodiment. In at least one embodiment, system 1000 includes one or more processor(s) 1002 and one or more graphics processor(s) 1008, and may be a single processor desktop system, a multiprocessor workstation system, or a server system having a large number of processor(s) 1002 or processor core(s) 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processor(s) 1002 and a graphical interface generated by one or more graphics processor(s) 1008.

In at least one embodiment, one or more processor(s) 1002 each include one or more processor core(s) 1007 to process instructions which, when executed, perform operations for system and user software. In at least one embodiment, each of one or more processor core(s) 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor core(s) 1007 may each process a different instruction set 1009, which may include instructions to facilitate emulation of other instruction sets. In at least one embodiment, processor core(s) 1007 may also include other processing devices, such a Digital Signal Processor (DSP).

In at least one embodiment, processor(s) 1002 includes cache memory 1004. In at least one embodiment, processor(s) 1002 can have a single internal cache or multiple levels of internal cache. In at least one embodiment, cache memory is shared among various components of processor(s) 1002. In at least one embodiment, processor(s) 1002 also uses an external cache (e.g., a Level-3 (L3) cache or Last Level Cache (LLC)) (not shown), which may be shared among processor core(s) 1007 using known cache coherency techniques. In at least one embodiment, register file 1006 is additionally included in processor(s) 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor(s) 1002 and other components in system 1000. In at least one embodiment, interface bus(es) 1010, in one embodiment, can be a processor bus, such as a version of a Direct Media Interface (DMI) bus. In at least one embodiment, interface bus(es) 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instruction 1021 for use when one or more processor(s) 1002 executes an application or process. In at least one embodiment, memory controller 1016 also couples with an optional external graphics processor 1012, which may communicate with one or more graphics processor(s) 1008 in processor(s) 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor(s) 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus(es) 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controller(s) 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Inference and/or training logic 715 are used to perform inferencing and/or training operations associated with one or more embodiments. In at least one embodiment portions or all of inference and/or training logic 715 may be incorporated into graphics processor(s) 1008. For example, in at least one embodiment, training and/or inferencing techniques described herein may use one or more of ALUs embodied in a graphics processor. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used for live migration.

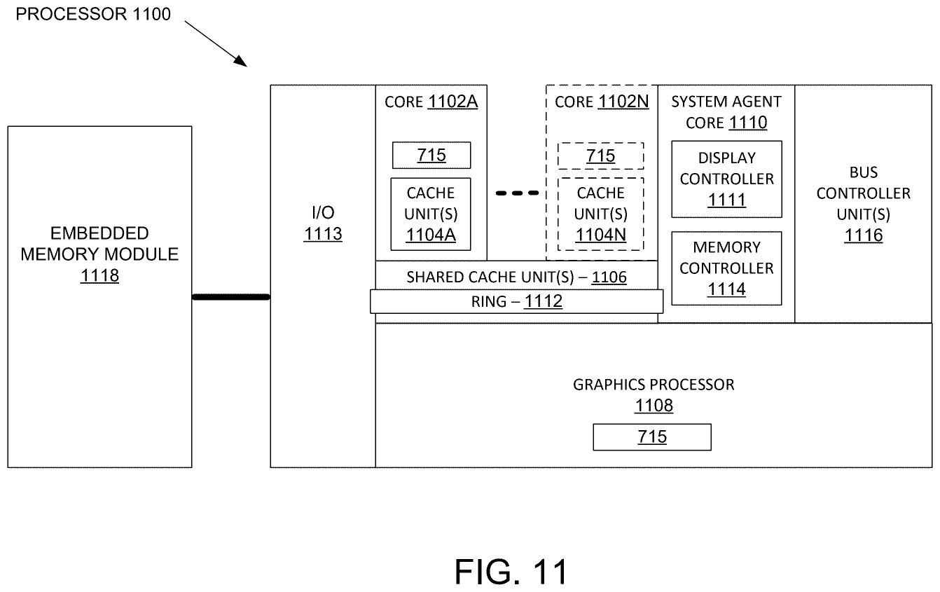

FIG. 11 is a block diagram of a processor 1100 having one or more processor core(s) 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor core(s) 1102A-1102N includes one or more internal cache unit(s) 1104A-1104N. In at least one embodiment, each processor core also has access to one or more shared cached unit(s) 1106.

In at least one embodiment, internal cache unit(s) 1104A-1104N and shared cache unit(s) 1106 represent a cache memory hierarchy within processor 1100. In at least one embodiment, cache unit(s) 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1106 and 1104A-1104N.

In at least one embodiment, processor 1100 may also include a set of one or more bus controller unit(s) 1116 and a system agent core 1110. In at least one embodiment, one or more bus controller unit(s) 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor core(s) 1102A-1102N include support for simultaneous multi-threading. In at least one embodiment, system agent core 1110 includes components for coordinating and operating processor core(s) 1102A-1102N during multi-threaded processing. In at least one embodiment, system agent core 1110 may additionally include a power control unit (PCU), which includes logic and components to regulate one or more power states of processor core(s) 1102A-1102N and graphics processor 1108.

In at least one embodiment, processor 1100 additionally includes graphics processor 1108 to execute graphics processing operations. In at least one embodiment, graphics processor 1108 couples with shared cache unit(s) 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring based interconnect unit 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor core(s) 1102A-1102N and graphics processor 1108 use embedded memory modules 1118 as a shared Last Level Cache.

In at least one embodiment, processor core(s) 1102A-1102N are homogenous cores executing a common instruction set architecture. In at least one embodiment, processor core(s) 1102A-1102N are heterogeneous in terms of instruction set architecture (ISA), where one or more of processor core(s) 1102A-1102N execute a common instruction set, while one or more other cores of processor core(s) 1102A-1102N executes a subset of a common instruction set or a different instruction set. In at least one embodiment, processor core(s) 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Inference and/or training logic 715 are used to perform inferencing and/or training operations associated with one or more embodiments. In at least one embodiment portions or all of inference and/or training logic 715 may be incorporated into processor 1100. For example, in at least one embodiment, training and/or inferencing techniques described herein may use one or more of ALUs embodied in graphics processor 1108, processor core(s) 1102A-1102N, or other components in FIG. 11. In at least one embodiment, weight parameters may be stored in on-chip or off-chip memory and/or registers (shown or not shown) that configure ALUs of graphics processor 1100/1108 to perform one or more machine learning algorithms, neural network architectures, use cases, or training techniques described herein.

Such components can be used for live migration.

Various embodiments can be described by the following clauses:

1. A processor comprising:
one or more processing circuits to:
   determine a source memory location of data responsive to a migration request;
   establish a data communication channel to a network component;
   establish a secure communication channel to the network component;
   transmit a key associated with the data to the network component using the secure communication channel; and
   transmit a descriptor of the source memory location to the network component using the data communication channel.
      2. The processor of clause 1, wherein the one or more processing circuits are further to:
decrypt the data from an encrypted buffer of a virtual machine; and
encrypt the data within a plaintext buffer.
   3. The processor of clause 2, wherein the source memory location is the plaintext buffer.
   4. The processor of clause 1, where the source memory location is an encrypted buffer of a virtual machine.
   5. The processor of clause 1, wherein the descriptor is a plaintext descriptor.
   6. The processor of clause 1, wherein the one or more processing circuits are further to:
receive the migration request from an untrusted hypervisor in communication with the network component using the data communication channel.
   7. A computer-implemented method, comprising:
receiving, from an untrusted hypervisor, a request to migrate data from a first encrypted memory location to a second encrypted memory location;
establishing a secure channel to a network interface controller (NIC);
transmitting, to the NIC using the secure channel, a key corresponding to a credential to access the data;
generating a descriptor indicative of an access location for the data;
transmitting, to the NIC using the untrusted hypervisor, the descriptor; and
causing, using the key, the data to migrate from the first encrypted memory location to the second encrypted memory location.
   8. The computer-implemented method of clause 7, wherein the descriptor is an unencrypted plaintext descriptor.
   9. The computer-implemented method of clause 7, wherein the first encrypted memory location is associated with a first virtual machine and the second encrypted memory location is associated with a second virtual machine.
   10. The computer-implemented method of clause 7, further comprising:
decrypting the data in the first encrypted memory location;
encrypting the data using the key; and
storing the data encrypted using the key in a plaintext buffer.
   11. The computer-implemented method of clause 10, wherein the access location corresponds to the plaintext buffer.
   12. The computer-implemented method of clause 10, wherein the plaintext buffer is associated with a secure hypervisor.
   13. The computer-implemented method of clause 7, wherein the access location corresponds to the first encrypted memory location of a confidential virtual machine.
   14. A computer-implemented method, comprising:
receiving, at a first secure hypervisor, a request to move data from a first encrypted memory location to a second encrypted memory location;
establishing a first secure channel between the first secure hypervisor and a first network interface controller (NIC);
transmitting, to the first NIC using the first secure channel, a key associated with the data;
generating a descriptor indicative of an access location for the data;
transmitting, to the first NIC using a first untrusted hypervisor, the descriptor;
receiving, at a second NIC, the descriptor;
receiving, at a second secure hypervisor from a second untrusted hypervisor, the descriptor; and
storing, using the descriptor and the key, the data at the second encrypted memory location.
   15. The computer-implemented method of clause 14, wherein the descriptor is an unencrypted plaintext descriptor.
   16. The computer-implemented method of clause 14, further comprising:
receiving the data at a first secure hypervisor plaintext buffer, the first secure hypervisor plaintext buffer being the access location;
receiving the data a second secure hypervisor plaintext buffer;
decrypting the data using the key; and
providing the data to the second encrypted memory location.
   17. The computer-implemented method of clause 14, wherein the access location is the first encrypted memory location.
   18. The computer-implemented method of clause 14, wherein the first encrypted memory location is associated with a first virtual machine and the second encrypted memory location is associated with a second virtual machine.
   19. The computer-implemented method of clause 14, wherein at least one of the first NIC or the second NIC includes a data processing unit.
   20. The computer-implemented method of clause 14, further comprising:
transmitting the data using at least one of Transmission Control Protocol/Internet Protocol (TCP/IP) or remote direct memory access (RDMA).

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising:
one or more processing circuits to:
determine a source memory location of data responsive to a migration request;
establish a data communication channel to a network component;
establish a secure communication channel to the network component;
transmit a key associated with the data to the network component using the secure communication channel; and
transmit a descriptor of the source memory location to the network component using the data communication channel.

2. The processor of claim 1, wherein the one or more processing circuits are further to:
decrypt the data from an encrypted buffer of a virtual machine; and
encrypt the data within a plaintext buffer.

3. The processor of claim 2, wherein the source memory location is the plaintext buffer.

4. The processor of claim 1, where the source memory location is an encrypted buffer of a virtual machine.

5. The processor of claim 1, wherein the descriptor is a plaintext descriptor.

6. The processor of claim 1, wherein the one or more processing circuits are further to:
receive the migration request from an untrusted hypervisor in communication with the network component using the data communication channel.

7. A computer-implemented method, comprising:
receiving, from an untrusted hypervisor, a request to migrate data from a first encrypted memory location to a second encrypted memory location;
establishing a secure channel to a network interface controller (NIC);
transmitting, to the NIC using the secure channel, a key corresponding to a credential to access the data;
generating a descriptor indicative of an access location for the data;
transmitting, to the NIC using the untrusted hypervisor, the descriptor; and
causing, using the key, the data to migrate from the first encrypted memory location to the second encrypted memory location.

8. The computer-implemented method of claim 7, wherein the descriptor is an unencrypted plaintext descriptor.

9. The computer-implemented method of claim 7, wherein the first encrypted memory location is associated with a first virtual machine and the second encrypted memory location is associated with a second virtual machine.

10. The computer-implemented method of claim 7, further comprising:
decrypting the data in the first encrypted memory location;
encrypting the data using the key; and
storing the data encrypted using the key in a plaintext buffer.

11. The computer-implemented method of claim 10, wherein the access location corresponds to the plaintext buffer.

12. The computer-implemented method of claim 10, wherein the plaintext buffer is associated with a secure hypervisor.

13. The computer-implemented method of claim 7, wherein the access location corresponds to the first encrypted memory location of a confidential virtual machine.

14. A computer-implemented method, comprising:
receiving, at a first secure hypervisor, a request to move data from a first encrypted memory location to a second encrypted memory location;
establishing a first secure channel between the first secure hypervisor and a first network interface controller (NIC);
transmitting, to the first NIC using the first secure channel, a key associated with the data;
generating a descriptor indicative of an access location for the data;
transmitting, to the first NIC using a first untrusted hypervisor, the descriptor;
receiving, at a second NIC, the descriptor;
receiving, at a second secure hypervisor from a second untrusted hypervisor, the descriptor; and
storing, using the descriptor and the key, the data at the second encrypted memory location.

15. The computer-implemented method of claim 14, wherein the descriptor is an unencrypted plaintext descriptor.

16. The computer-implemented method of claim 14, further comprising:
receiving the data at a first secure hypervisor plaintext buffer, the first secure hypervisor plaintext buffer being the access location;
receiving the data a second secure hypervisor plaintext buffer;
decrypting the data using the key; and
providing the data to the second encrypted memory location.

17. The computer-implemented method of claim 14, wherein the access location is the first encrypted memory location.

18. The computer-implemented method of claim 14, wherein the first encrypted memory location is associated with a first virtual machine and the second encrypted memory location is associated with a second virtual machine.

19. The computer-implemented method of claim 14, wherein at least one of the first NIC or the second NIC includes a data processing unit.

20. The computer-implemented method of claim 14, further comprising:
transmitting the data using at least one of Transmission Control Protocol/Internet Protocol (TCP/IP) or remote direct memory access (RDMA).
